(19) United States
(12) Patent Application Publication
(10) Pub. No.: US 2011/0175599 A1
(43) Pub. Date: Jul. 21, 2011

(54) Input device with dual induction coils and rotation motion output method thereof

(75) Inventor: Chih Min Liu, Taipei (TW)

(73) Assignee: KYE SYSTEMS CORP., Taipei (TW)

(21) Appl. No.: 12/662,793

(22) Filed: May 4, 2010

(30) Foreign Application Priority Data
Jan. 20, 2010 (TW) 099101544

(51) Int. Cl. G01B 7/15

(52) U.S. Cl. 324/207.17

(57) ABSTRACT

An input device with dual induction coils and a rotation motion output method thereof are described, in which the input device moves on a trace capture device, such that the trace capture device outputs a trace signal to an electronic device. When the input device is rotated on the trace capture device, two coils within the input device respectively send an induction signal to the trace capture device. Then, the trace capture device respectively converts the two induction signals to two position signals, so as to determine displacement amounts and rotation directions of the two position signals, such that the trace capture device outputs a rotation signal to the electronic device, and the electronic device correspondingly executes a motion instruction according to the rotation signal.

### CROSS-REFERENCE TO RELATED APPLICATIONS

This non-provisional application claims priority under 35 U.S.C. §119(a) on Patent Application No(s). 099101544 filed in Taiwan, R.O.C. on Jan. 20, 2010, the entire contents of which are hereby incorporated by reference.

### BACKGROUND OF THE INVENTION

1. Field of the Invention

The present invention relates to an input device with dual induction coils, and more particularly to an input device with dual induction coils and a rotation motion output method thereof.

2. Related Art

With the rapid progress of computer technology, a recording manner of the modern people has gradually been replaced by a manner of using the computer. Generally, the computer is controlled and operated by using a mouse and a keyboard. However, if the mouse and the keyboard are used for controlling the computer in drawing, it is inherently inconvenient and restricted. Therefore, a digital pen and a digital board have been gradually developed, such that people utilize the digital pen and the digital board in writing or drawing, which is as convenient as the recording manner of using pen and paper in the past.

For example, a conventional digital board decides a moving trace of a digital pen by utilizing the movement of the digital pen on the digital board, that is, by calculating coordinates and coordinate changes in the two-dimensional space. In some prior art, an electromagnetic field induction technique is utilized. In the technique, an electromagnetic induction voltage of the digital pen is detected by using a plurality of electromagnetic induction antenna loops on the digital board, so as to decide a coordinate position of the digital pen relative to the digital board, thereby executing scrolling, clicking, or tracing of the pointer, or text writing, drawing, as well as other functions in a window frame.

However, although the input manner of manipulating the pointer by using the digital pen is quite convenient, it only provides a relative displacement amount and a moving trace required by a cursor on the common window frame, such that an application scope is quite limited. Furthermore, a writing area on the digital board provided for a user to write with the digital pen is quite limited. When the user uses the graphic software, if the user intends to draw a straight line, a displacement distance of the digital pen is usually restricted by the writing area of the digital board, and as a result, the drawn straight line may be discontinuous. Therefore, such input manner is still inconvenient for drawing.

### SUMMARY OF THE INVENTION

In view of the above problems, the present invention is an input device with dual induction coils and a rotation motion output method thereof, in which the input device is not limited by a writing area of a digital board, and the input device is rotated to switch between two modes (for example, switching of a window frame or zooming in/out of the window frame), such that an operating system can be more conveniently and quickly operated.

The present invention provides an input device with dual induction coils, which moves on a trace capture device, such that the trace capture device outputs a trace signal to an electronic device. The input device comprises a primary coil, a secondary coil, and a radio frequency (RF) circuit. The primary coil sends a primary induction signal, and the secondary coil sends a secondary induction signal. The RF circuit is electrically connected to the primary coil and the secondary coil, and transfers the primary induction signal and the secondary induction signal to the trace capture device. In a first time period, the trace capture device converts the primary induction signal and the secondary induction signal to a first primary position signal and a first secondary position signal. In a second time period, the input device is rotated, and the trace capture device converts the primary induction signal and the secondary induction signal to a second primary position signal and a second secondary position signal. Then, the first primary position signal is compared with the second primary position signal, and the first secondary position signal is compared with the second secondary position signal, such that the trace capture device outputs a rotation signal to the electronic device, and the electronic device correspondingly executes a motion instruction according to the rotation signal.

The present invention provides a rotation motion output method for an input device with dual induction coils, which comprises the following steps. A primary coil sends a primary induction signal, and a secondary coil sends a secondary induction signal. In a first time period, a trace capture device receives the primary induction signal and the secondary induction signal, and converts the primary induction signal and the secondary induction signal to a first primary position signal and a first secondary position signal. In a second time period, the input device is rotated, and the trace capture device receives the primary induction signal and the secondary induction signal again, and converts the primary induction signal and the secondary induction signal to a second primary position signal and a second secondary position signal. The first primary position signal is compared with the second primary position signal, and the first secondary position signal is compared with the second secondary position signal, such that the trace capture device outputs a rotation signal to an electronic device, and the electronic device correspondingly executes a motion instruction according to the rotation signal.

The present invention achieves the following efficacies. When the input device is rotated on the trace capture device, the trace capture device outputs a clockwise or anti-clockwise rotation signal to the electronic device, so as to switch the electronic device to execute a motion instruction, for example, the trace capture device outputs the clockwise or anti-clockwise rotation signal to switch a window frame of the electronic device to perform clockwise or anti-clockwise rotation, or switch the window frame to be zoomed in or zoomed out, so as to facilitate the switching of the window frame of the operating system. What's more, an operation of rotating an object in the window frame can be realized, for example, a 3D model is drawn by using the graphic software, and then the input device is rotated to correspondingly control the 3D model to be rotated in various angles.

### BRIEF DESCRIPTION OF THE DRAWINGS

The present invention will become more fully understood from the detailed description given herein below for illustration only, and thus are not limitative of the present invention, and wherein:

FIG. 1 is a schematic view of an input device on a trace capture device according to a first embodiment of the present invention;

FIG. 2 is a schematic view of an input device on a trace capture device according to a second embodiment of the present invention;

FIG. 3 is a schematic view of an input device on a trace capture device according to a third embodiment of the present invention;

FIG. 4 is a schematic view of an input device on a trace capture device according to a fourth embodiment of the present invention;

FIG. 5 is a flow chart of a rotation signal outputting method for an input device with dual induction coils according to the present invention;

FIGS. 6 and 7 are schematic views of determining a rotation direction of an input device with dual induction coils according to an embodiment of the present invention;

FIG. 8 is a schematic view of an input device on a trace capture device according to a fifth embodiment of the present invention; and

FIGS. 9 and 10 are schematic views of determining a rotation direction of an input device with dual induction coils according to another embodiment of the present invention.

### DETAILED DESCRIPTION OF THE INVENTION

An input device with dual induction coils and a rotation motion output method thereof are described in detail below in the preferred embodiments. The concepts of the present invention can also be applied to other scopes. The embodiments below are only intended to illustrate the objectives and method of the present invention, instead of limiting the scope of the present invention.

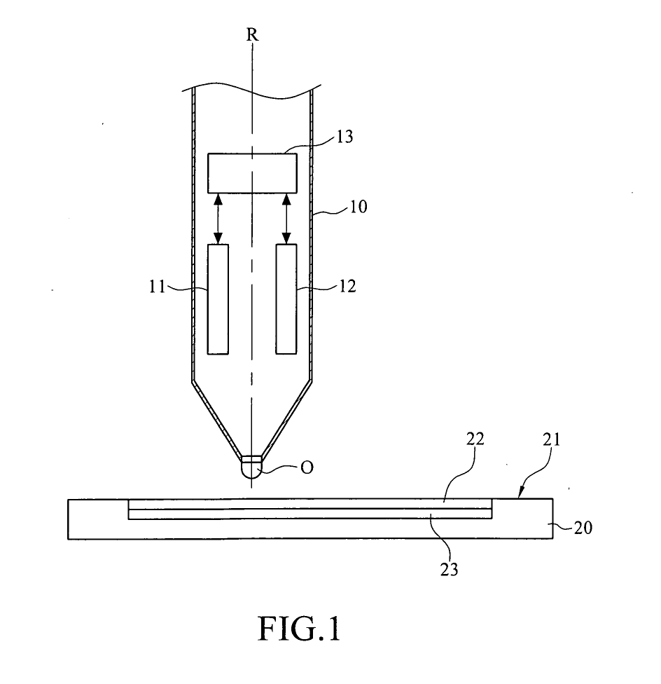

FIG. 1 is a schematic view of an input device on a trace capture device according to a first embodiment of the present invention. Referring to FIG. 1, an input device 10 may be designed into a pen structure, but the present invention is not limited hereto. A primary coil 11 and a secondary coil 12 (it should be noted that “primary” or “secondary” is only used to differentiate the two coils, without other restrictions) are respectively disposed in the input device 10. A pen point O of the input device 10 is taken as an axle center R, and the primary coil 11 and the secondary coil 12 are respectively arranged on two opposite side edges of the axle center R side by side. In addition, the input device 10 further has an RF circuit 13, and the primary coil 11 and the secondary coil 12 are electrically connected to the RF circuit 13 respectively.

In this embodiment, the primary coil 11 generates a primary induction signal, and the secondary coil 12 generates a secondary induction signal. A primary frequency section of the primary induction signal does not overlap with a secondary frequency section of the secondary induction signal. For example, the primary frequency section of the primary induction signal may be 120 KHz-250 KHz, and the secondary frequency section of the secondary induction signal may be 40 KHz-80 KHz, but the present invention is not limited hereto.

In addition, the trace capture device 20 may be a digital board, but the present invention is not limited hereto. The trace capture device 20 comprises a working area 21, so that the input device 10 is enabled to move on the working area 21. The working area 21 is formed by a plurality of crossed signal lines in an X axis direction and a Y axis direction, and has a primary induction circuit 22 and a secondary induction circuit 23 formed thereon. Once the pen point O of the input device 10 contacts the working area 21, the primary induction signal generated by the primary coil 11 is transmitted to the primary induction circuit 22 through the RF circuit 13. Similarly, the secondary induction signal generated by the secondary coil 12 is transmitted to the secondary induction circuit 23 through the RF circuit 13.

In brief, when the user holds the input device 10 to perform a trace displacement motion on the working area 21 of the trace capture device 20, the RF circuit 13 synchronously sends the primary induction signal and the secondary induction signal with different frequencies to the trace capture device 20. Meanwhile, the primary induction circuit 22 and the secondary induction circuit 23 respectively receive the primary induction signal and the secondary induction signal, and convert the primary induction signal and the secondary induction signal to a primary position signal and a secondary position signal (for example, in a filtering manner), so as to determine a traveling trace of the input device 10 on the trace capture device 20. However, the process of acquiring a moving trace (for example, a straight line, an oblique line, or a curve, etc.) of the input device 10 by the trace capture device 20 belongs to the prior art, so that it is not described in detail here.

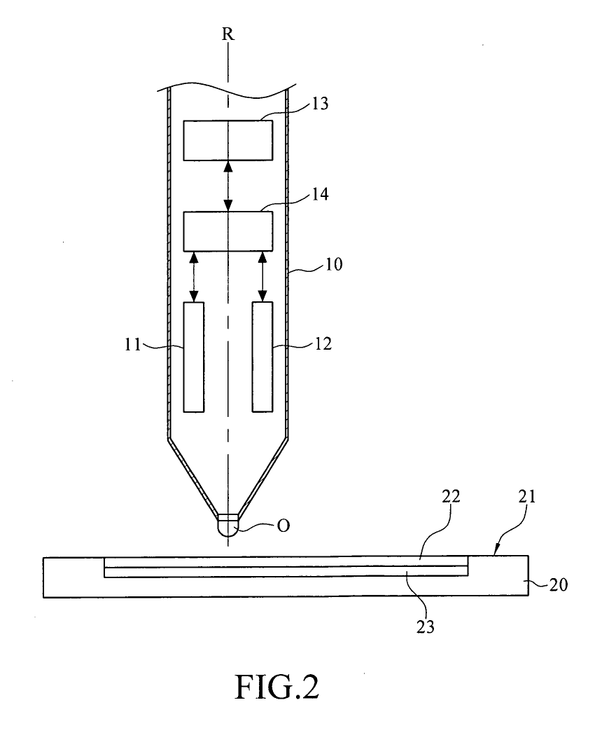

Then, the present invention is described through another embodiment. FIG. 2 is a schematic view of an input device on a trace capture device according to a second embodiment of the present invention. The detailed implementation is approximately the same as the above embodiment, and only differences are described in the following. Referring to FIG. 2, an input device 10 further comprises a switch 14 electrically connected to a primary coil 11 and a secondary coil 12 respectively. The primary coil 11 generates a primary induction signal, the secondary coil 12 generates a secondary induction signal, and a primary frequency section of the primary induction signal is made to overlap with a secondary frequency section of the secondary induction signal.

In this embodiment, the switch 14 alternately transfers the primary induction signal or the secondary induction signal to an RF circuit 13. In brief, when the switch 14 transmits the primary induction signal, the secondary induction signal is temporarily stored in a buffer storage (not shown). Then, after finishing transmitting the primary induction signal, the switch 14 transmits the secondary induction signal to the RF circuit 13, and at this time, the primary induction signal turns to be temporarily stored in a storage (not shown). In this manner, the switch 14 alternately transmits the primary induction signal and the secondary induction signal to the RF circuit 13 respectively within a specific time interval.

Therefore, according to the specific time or receiving times set by the switch 14, the RF circuit 13 is made to alternately receive the primary induction signal and the secondary induction signal in different time periods, and then the RF circuit 13 alternately transfers the primary induction signal and the secondary induction signal to a primary induction circuit 22 and a secondary induction circuit 23 of a trace capture device 20 for being received, so as to determine a position of the input device 10 on the trace capture device 20.

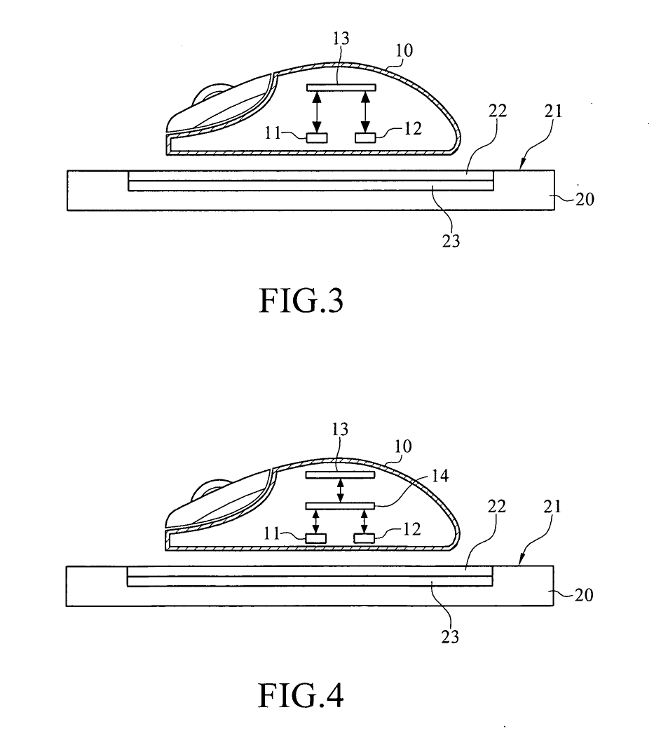

In addition, the input device 10 according to the present invention is not limited to a digital pen or other pen-shaped structures, and the input device 10 may also be designed into a mouse structure. FIG. 3 is a schematic view of an input device on a trace capture device according to a third embodiment of the present invention. The detailed implementation is approximately the same as the above embodiment, and only differences are described in the following. Referring to FIG. 3, an input device 10 may be a mouse structure (for example, a wired mouse or wireless mouse), a primary coil 11 and a secondary coil 12 are respectively disposed within the input device 10 side by side, and the primary coil 11 and the secondary coil 12 are electrically connected to an RF circuit 13 respectively.

In this manner, the user may hold the input device 10 to move on a working area 21 of a trace capture device 20. At this time, a primary induction signal generated by the primary coil 11 is transmitted to a primary induction circuit 22 through the RF circuit 13. Similarly, a secondary induction signal generated by the secondary coil 12 is transmitted to a secondary induction circuit 23 through the RF circuit 13. Thus, when the user manipulates the input device 10 (for example, the wireless mouse), the RF circuit 13 synchronously sends the primary induction signal and the secondary induction signal to the primary induction circuit 22 and the secondary induction circuit 23, and then the primary induction signal and the secondary induction signal are respectively converted to a primary position signal and a secondary position signal (for example, in a filtering manner), so as to determine a traveling trace of the input device 10 on the trace capture device 20.

In addition, FIG. 4 is a schematic view of an input device on a trace capture device according to a fourth embodiment of the present invention. The detailed implementation is approximately the same as the above embodiment, and only differences are described in the following. Referring to FIG. 4, in this embodiment, an input device 10 (for example, a mouse structure) further comprises a switch 14 therein, and the switch 14 is electrically connected to a primary coil 11 and a secondary coil 12 respectively. A primary frequency section of a primary induction signal generated by the primary coil 11 is made to overlap with a secondary frequency section of a secondary induction signal generated by the secondary coil 12.

Therefore, the switch 14 alternately transfers the primary induction signal or the secondary induction signal to an RF circuit 13 in different time periods, and then the RF circuit 13 alternately transfers the primary induction signal and the secondary induction signal to a primary induction circuit 22 and a secondary induction circuit 23 of a trace capture device 20 for being received, so as to determine a traveling trace of the input device 10 on the trace capture device 20.

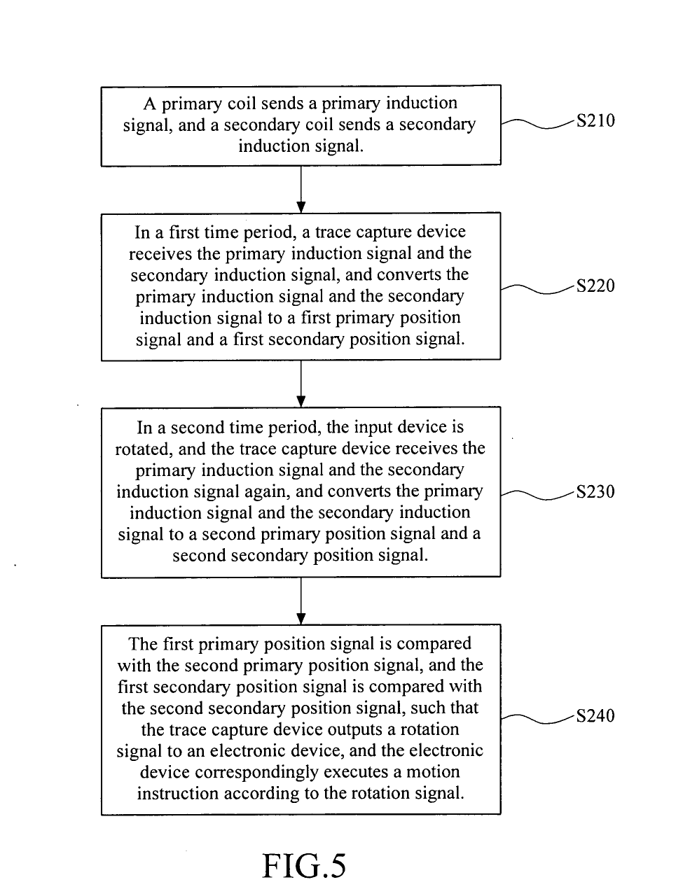

FIG. 5 is a flow chart of a rotation signal outputting method for an input device with dual induction coils. The input device with any structure of the above embodiments is applicable to the flow chart of the method shown in FIG. 5. Referring to FIG. 5, firstly, a primary coil 11 sends a primary induction signal, and a secondary coil 12 sends a secondary induction signal (Step S210). In a first time period, a trace capture device 20 receives the primary induction signal and the secondary induction signal, and converts the primary induction signal and the secondary induction signal to a first primary position signal and a first secondary position signal (Step S220). In a second time period, the input device 10 is rotated, and the trace capture device 20 receives the primary induction signal and the secondary induction signal again, and converts the primary induction signal and the secondary induction signal to a second primary position signal and a second secondary position signal (Step S230). The first primary position signal is compared with the second primary position signal, and the first secondary position signal is compared with the second secondary position signal, such that the trace capture device outputs a rotation signal to an electronic device, and the electronic device correspondingly executes a motion instruction according to the rotation signal (Step S240).

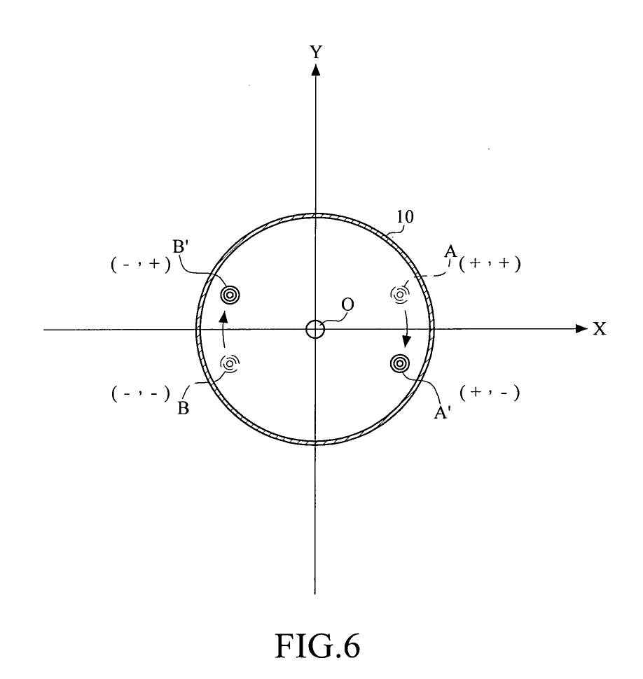

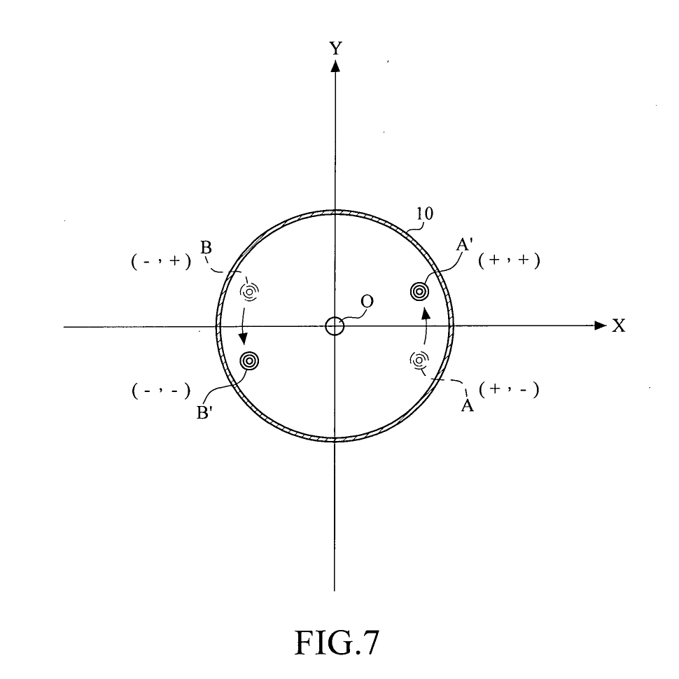

The manner of outputting the signal of the rotation direction is described in detail below with reference to FIGS. 6 and 7, which may be applied to each embodiment of FIGS. 1 to 4, but the present invention is not limited to the above embodiments. FIGS. 6 and 7 are schematic views of determining a rotation direction of an input device with dual induction coils. Referring to FIGS. 6 and 7, X and Y represent an X axis direction and a Y axis direction in two-dimensional coordinates, and a pen point O of the input device 10 is taken as a cross point of the X axis and the Y axis, such that a first quadrant (+,+), a second quadrant (−,+), a third quadrant (−,−), and a fourth quadrant (+,−) are divided on the X axis and the Y axis. A primary induction signal generated by a primary coil 11 and a secondary induction signal generated by a secondary coil 12 are respectively converted to a first primary position signal A and a first secondary position signal B, so as to determine positions of the first primary position signal A (hereafter referred to as Point A) and the first secondary position signal B (hereafter referred to as Point B) in each quadrant.

When rotating the input device 10, the user takes the pen point O as a reference point, or takes a middle point between the primary coil 11 and the secondary coil 12 as the reference point, and makes the Point A move to a Point A′ (i.e., a second primary position signal A′), and makes the Point B move to a Point B′ (i.e., a second secondary position signal B′). When the Point A is moved to the Point A′ and the Point B is moved to the Point B′ according to a direction sequence of the first quadrant→the second quadrant→the third quadrant→the fourth quadrant (as shown in FIG. 6), a trace capture device 20 determines that the input device 10 is rotated along an anti-clockwise direction, so as to output an anti-clockwise rotation signal to an electronic device (not shown), thereby controlling the electronic device to switch to a first mode.

When the Point A is moved to the Point A′ and the Point B is moved to the Point B′ according to a direction sequence of the first quadrant→the fourth quadrant→the third quadrant→the second quadrant (as shown in FIG. 7), the trace capture device 20 determines that the input device 10 is rotated along a clockwise direction, so as to output a clockwise rotation signal to the electronic device (not shown), thereby controlling the electronic device to switch to a second mode.

It should be understood that, when the input device 10 is rotated, the trace capture device 20 may also simply determine coordinate changes on the X axis and the Y axis after the Point A is moved to the Point A′, and determine coordinate changes on the X axis and the Y axis after the Point B is moved to the Point B′. Definitely, a movement amount of the Point A on the X axis and the Y axis is the “same” as a movement amount of the Point B on the X axis and the Y axis and the moving directions thereof are “opposite”, such that the trace capture device 20 may determine that the input device 10 performs a clockwise or anti-clockwise rotation. For example, when a coordinate of the Point A on the Y axis is changed from large to small, whereas a coordinate of the Point B on the Y axis is changed from small to large, the input device 10 is determined to perform a clockwise rotation.

In this manner, the input device 10 is rotated on the trace capture device 20, and then the trace capture device 20 determines the rotation direction (for example, the clockwise direction or the anti-clockwise direction) of the input device 10, so as to output a corresponding clockwise direction rotation signal or a corresponding anti-clockwise direction rotation signal to the electronic device, such that the electronic device correspondingly executes a motion instruction according to the rotation direction signal. For example, when the input device 10 performs a clockwise rotation, a window frame of the electronic device (for example, a computer) is manipulated to perform a clockwise rotation (i.e., executing the first mode). When the input device 10 performs an anti-clockwise rotation, the window frame is manipulated to perform an anti-clockwise rotation (i.e., executing the second mode).

However, it is merely an embodiment for description, but not intended to limit the scope of the present invention. The clockwise or anti-clockwise direction for rotating the input device 10 may be made to correspond to the motion instruction for manipulating the electronic device, which comprises, but not limited to, a function of zooming in or zooming out the window frame, or a function of rotating an object in the window frame, for example, the object may be a 3D model drawn by using an application (for example, graphic software), and the rotation direction of the input device 10 is used to correspondingly control the 3D model to be rotated for any angle in 360°. The clockwise rotation signal and the anti-clockwise rotation signal are merely needed to manipulate the electronic device to switch between the first mode and the second mode or execute the motion instruction corresponding to the rotation signal.

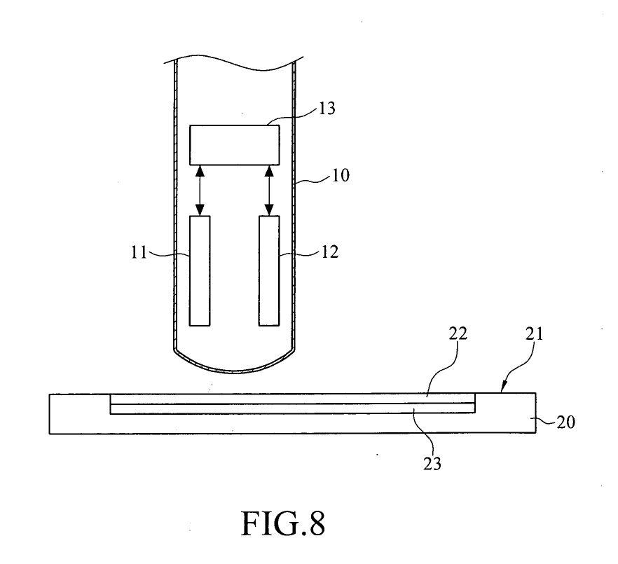

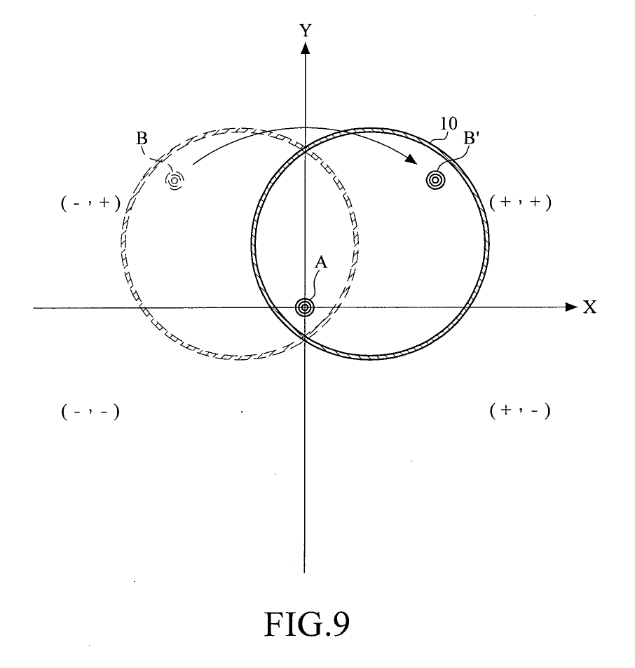

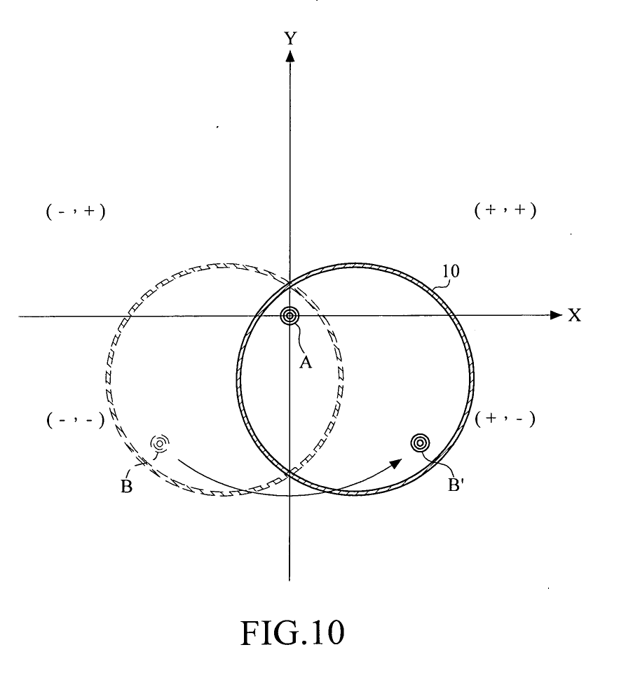

Furthermore, another manner of outputting the signal of the rotation direction is described in detail below through another embodiment with reference to FIGS. 9 and 10, which may be applied to the embodiment of FIG. 8, but the present invention is not limited hereto. FIGS. 9 and 10 are schematic views of determining a rotation direction of an input device with dual induction coils. Referring to FIGS. 9 and 10, X and Y represent an X axis direction and a Y axis direction in two-dimensional coordinates. In this embodiment, a first primary position signal A generated by a primary coil 11 of an input device 10 is taken as a reference point, or the first primary position signal A is located at a cross point of the X axis and the Y axis, such that a first quadrant (+,+), a second quadrant (−,+), a third quadrant (−,−), and a fourth quadrant (+,−) are divided on the X axis and the Y axis. A first secondary position signal B generated by a secondary coil 12 may perform a rotation displacement relative to the first primary position signal A.

When rotating the input device 10, the user takes the first primary position signal A of the primary coil 11 as the reference point, that is, the Point A maintains unchanged, and the user makes the Point B move to a Point B′ (i.e., a second secondary position signal B′).

When the Point B is moved to the Point B′ according to a direction sequence of the first quadrant→the fourth quadrant→the third quadrant→the second quadrant (as shown in FIG. 9), a trace capture device 20 determines that the input device 10 is rotated along a clockwise direction, so as to output a clockwise rotation signal to the electronic device (not shown), thereby controlling the electronic device to switch the mode or execute a specific motion instruction.

When the Point B is moved to the Point B′ according to a direction sequence of the first quadrant→the second quadrant→the third quadrant→the fourth quadrant (as shown in FIG. 10), the trace capture device 20 determines that the input device 10 is rotated along an anti-clockwise direction, so as to output an anti-clockwise rotation signal to the electronic device (not shown), thereby controlling the electronic device to switch the mode or execute a specific motion instruction.

It should be understood that, the user may also take the first secondary position signal B of the secondary coil 12 as the reference point, and the first primary position signal A of the primary coil 11 is rotated relative to the first secondary position signal B. The determining manner is the same as that mentioned above, so that it is not further discussed here.

What is claimed is:

1. An input device with dual induction coils, moving on a trace capture device, such that the trace capture device outputs a trace signal to an electronic device, the input device with dual induction coils comprising:
a primary coil, for sending a primary induction signal;
a secondary coil, for sending a secondary induction signal; and
a radio frequency (RF) circuit, electrically connected to the primary coil and the secondary coil, and transferring the primary induction signal and the secondary induction signal to the trace capture device;
wherein in a first time period, the trace capture device converts the primary induction signal and the secondary induction signal to a first primary position signal and a first secondary position signal; in a second time period, the input device is rotated, and then the trace capture device converts the primary induction signal and the secondary induction signal to a second primary position signal and a second secondary position signal; and the first primary position signal is compared with the second primary position signal, and the first secondary position signal is compared with the second secondary position signal, such that the trace capture device outputs a rotation signal to the electronic device, and the electronic device correspondingly executes a motion instruction according to the rotation signal.

2. The input device with dual induction coils according to claim 1, wherein the input device has a reference point between the primary coil and the secondary coil, and the input device is rotated on the trace capture device about the reference point.

3. The input device with dual induction coils according to claim 1, wherein the input device takes the primary coil or the secondary coil as a reference point, and the input device is rotated on the trace capture device about the reference point.

4. The input device with dual induction coils according to claim 1, wherein the primary induction signal has a primary frequency section, the secondary induction signal has a secondary frequency section, the primary frequency section is different from the secondary frequency section, and the RF circuit synchronously sends the primary induction signal and the secondary induction signal to the trace capture device.

5. The input device with dual induction coils according to claim 1, wherein the primary induction signal has a primary frequency section, the secondary induction signal has a secondary frequency section, the primary frequency section is the same as the secondary frequency section, the RF circuit has a switch, the switch alternately transmits the primary induction signal and the secondary induction signal to the RF circuit, and then the RF circuit alternately sends the primary induction signal and the secondary induction signal to the trace capture device.

6. A rotation motion output method for an input device with dual induction coils, wherein the input device with dual induction coils moves on a trace capture device, the method comprising:
sending a primary induction signal by a primary coil, and sending a secondary induction signal by a secondary coil;
receiving the primary induction signal and the secondary induction signal by the trace capture device, and converting the primary induction signal and the secondary induction signal to a first primary position signal and a first secondary position signal in a first time period;
rotating the input device, receiving the primary induction signal and the secondary induction signal by the trace capture device again, and converting the primary induction signal and the secondary induction signal to a second primary position signal and a second secondary position signal in a second time period; and
comparing the first primary position signal with the second primary position signal, comparing the first secondary position signal with the second secondary position signal, such that the trace capture device outputs a rotation signal to an electronic device, and the electronic device correspondingly executes a motion instruction according to the rotation signal.

7. The rotation motion output method for the input device with dual induction coils according to claim 6, wherein the rotation signal is a clockwise rotation signal or an anti-clockwise rotation signal, when the electronic device receives the clockwise rotation signal, a window frame of the electronic device is controlled to perform clockwise rotation, and when the electronic device receives the anti-clockwise rotation signal, the window frame of the electronic device is controlled to perform anti-clockwise rotation.

8. The rotation motion output method for the input device with dual induction coils according to claim 6, wherein the rotation signal is a clockwise rotation signal or an anti-clockwise rotation signal, when the electronic device receives the clockwise rotation signal, a window frame of the electronic device is controlled to be zoomed in, and when the electronic device receives the anti-clockwise rotation signal, the window frame of the electronic device is controlled to be zoomed out.

9. The rotation motion output method for the input device with dual induction coils according to claim 6, wherein the input device has a reference point between the primary coil and the secondary coil, and the input device is rotated on the trace capture device about the reference point.

10. The rotation motion output method for the input device with dual induction coils according to claim 6, wherein the input device takes the primary coil or the secondary coil as a reference point, and the input device is rotated on the trace capture device about the reference point.
